(19) United States
(12) Patent Application Publication
(10) Pub. No.: US 2022/0118358 A1
(43) Pub. Date: Apr. 21, 2022

(54) COMPUTER-READABLE RECORDING MEDIUM, AND IMAGE GENERATION SYSTEM

(71) Applicant: SQUARE ENIX CO., LTD., Tokyo (JP)

(72) Inventor: Shinpei SAKATA, Tokyo (JP)

(73) Assignee: SQUARE ENIX CO., LTD., Tokyo (JP)

(21) Appl. No.: 17/450,203

(22) Filed: Oct. 7, 2021

(30) Foreign Application Priority Data
Oct. 20, 2020 (JP) 2020-176366

(51) Int. Cl. A63F 13/52; A63F 13/45; H04N 13/282; H04N 13/275

(52) U.S. Cl. CPC A63F 13/52; H04N 13/275; H04N 13/282; A63F 13/45

(57) ABSTRACT

Systems and non-transitory computer-readable media storing instructions to implement image generation are disclosed. An example image generation system includes: a client terminal; a server apparatus that connects to the client terminal by communication and further generates an image representing a progress status of a video game which uses a three-dimensional virtual space; and a computer that progresses the video game; specifies, using viewpoint coordinates as a viewpoint, a sight line direction of a viewpoint object corresponding to the viewpoint coordinates; and generates the image based on the specified sight line direction and a first attribute of the viewpoint object.

### CROSS REFERENCE TO RELATED APPLICATION(S)

The present disclosure claims priority to Japanese Patent Application No. 2020-176366, filed on Oct. 20, 2020, the disclosure of which is expressly incorporated herein by reference in its entirety for any purpose.

### BACKGROUND

The present disclosure relates to an image generation program and an image generation system.

A well-known image generation technology is used for staging including arranging an event in advance in the three-dimensional virtual space and generating an image in response to the event as a trigger or providing a photo prepared in advance to a user by causing a non player character (NPC) to look as if the NPC captures the photo, and does not provide an image autonomously captured by the NPC. Thus, this causes the user to feel bored.

### SUMMARY

A purpose of at least one embodiment of the present disclosure is to provide a new image generation program of higher interest.

According to a non-limiting aspect, the present disclosure is to provide a non-transitory computer-readable recording medium having recorded thereon an image generation program executed in a server apparatus of an image generation system that includes a client terminal and the server apparatus connectable to the client terminal by communication and generates an image representing a progress status of a video game which uses a three-dimensional virtual space, the image generation program causing the server apparatus to function to perform functions comprising, progressing the video game, specifying, using any viewpoint coordinates as a viewpoint for generating the image representing the progress status of the video game, a sight line direction of a viewpoint object that is an object corresponding to the viewpoint coordinates, and generating the image independently of an instruction operation of a player of the video game based on the specified sight line direction and a first attribute of the viewpoint object.

According to a non-limiting aspect, the present disclosure is to provide an image generation system that includes a client terminal and the server apparatus connectable to the client terminal by communication and generates an image representing a progress status of a video game which uses a three-dimensional virtual space, the image generation system comprising, progressing the video game, specifying, using any viewpoint coordinates as a viewpoint for generating the image representing the progress status of the video game, a sight line direction of a viewpoint object that is an object corresponding to the viewpoint coordinates, and generating the image independently of an instruction operation of a player of the video game based on the specified sight line direction and a first attribute of the viewpoint object.

According to a non-limiting aspect, the present disclosure is to provide a non-transitory computer-readable recording medium having recorded thereon an image generation program executed in a client terminal of an image generation system that includes the client terminal and a server apparatus connectable to the client terminal by communication and generates an image representing a progress status of a video game which uses a three-dimensional virtual space, the image generation program causing the client terminal to function to perform functions comprising, progressing the video game, specifying, using any viewpoint coordinates as a viewpoint for generating the image representing the progress status of the video game, a sight line direction of a viewpoint object that is an object corresponding to the viewpoint coordinates, and generating the image independently of an instruction operation of a player of the video game based on the specified sight line direction and a first attribute of the viewpoint object.

### BRIEF DESCRIPTION OF THE DRAWINGS

FIG. 1 is a block diagram illustrating a configuration of a server apparatus according to at least one embodiment of the present disclosure.

FIG. 2 is a flowchart of a program execution process according to at least one embodiment of the present disclosure.

FIG. 3 is a block diagram illustrating a configuration of a server apparatus according to at least one embodiment of the present disclosure.

FIG. 4 is a flowchart of a program execution process according to at least one embodiment of the present disclosure.

FIG. 5 is a block diagram illustrating a configuration of a system according to at least one embodiment of the present disclosure.

FIG. 6 is a block diagram illustrating a configuration of a system according to at least one embodiment of the present disclosure.

FIG. 7 is a flowchart related to an execution process according to at least one embodiment of the present disclosure.

FIG. 8 is a diagram for describing attributes according to at least one embodiment of the present disclosure.

FIGS. 9A and 9B are diagrams for describing a process of updating style sets according to at least one embodiment of the present disclosure.

FIG. 10 is a block diagram illustrating a configuration of a system according to at least one embodiment of the present disclosure.

FIG. 11 is a flowchart related to an execution process according to at least one embodiment of the present disclosure.

FIG. 12 is a diagram for describing attributes according to at least one embodiment of the present disclosure.

FIG. 13 is a block diagram illustrating a configuration of a computer apparatus according to at least one embodiment of the present disclosure.

FIG. 14 is a flowchart of a program execution process according to at least one embodiment of the present disclosure.

FIG. 15 is a block diagram illustrating a configuration of a computer apparatus according to at least one embodiment of the present disclosure.

FIG. 16 is a flowchart of a program execution process according to at least one embodiment of the present disclosure.

FIG. 17 is a block diagram illustrating a configuration of a computer apparatus according to at least one embodiment of the present disclosure.

FIG. 18 is a flowchart related to a program execution process according to at least one embodiment of the present disclosure.

### DESCRIPTION OF EMBODIMENTS

Hereinafter, embodiments of the disclosure will be described with reference to the accompanying drawings. Hereinafter, description relating to effects shows an aspect of the effects of the embodiments of the disclosure, and does not limit the effects. Further, the order of respective processes that form a flowchart described below may be changed in a range without contradicting or creating discord with the processing contents thereof.

### First Embodiment

A summary of a first embodiment of the present disclosure will be described. Hereinafter, as the first embodiment, an image generation program executed in a server apparatus of an image generation system that includes a client terminal and the server apparatus connectable to the client terminal by communication and generates an image representing a progress status of a video game which uses a three-dimensional virtual space will be illustratively described.

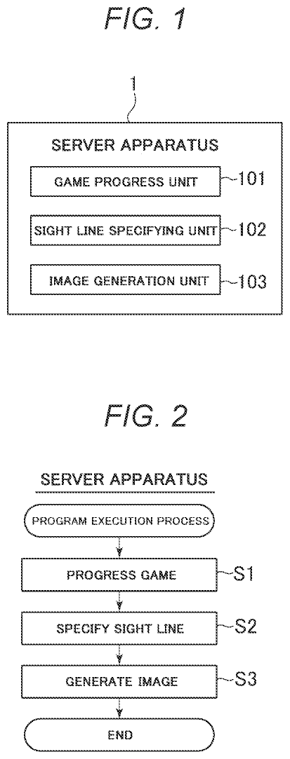

FIG. 1 is a block diagram illustrating a configuration of the server apparatus according to at least one embodiment of the present disclosure. A server apparatus 1 includes at least a game progress unit 101, a sight line specifying unit 102, and an image generation unit 103.

The game progress unit 101 has a function of progressing the video game. The sight line specifying unit 102 has a function of specifying, using any viewpoint coordinates as a viewpoint for generating the image representing the progress status of the video game, a sight line direction of a viewpoint object that is an object corresponding to the viewpoint coordinates. The image generation unit 103 has a function of generating the image independently of an instruction operation of a player of the video game based on the sight line direction specified by the sight line specifying unit 102 and a first attribute of the viewpoint object.

Next, a program execution process in the first embodiment of the present disclosure will be described. FIG. 2 is a flowchart of the program execution process according to at least one embodiment of the present disclosure.

The server apparatus 1 progresses the video game (step S1). Next, the server apparatus 1 specifies, using any viewpoint coordinates as the viewpoint for generating the image representing the progress status of the video dame, the sight line direction of the viewpoint object that is the object corresponding to the viewpoint coordinates (step S2). Next, the server apparatus 1 generates the image independently of the instruction operation of the player of the video game based on the specified sight line direction and the first attribute of the viewpoint object (step S3) and finishes the process.

As one aspect of the first embodiment, a new image generation program of higher interest can be provided.

In the first embodiment, for example, the “client terminal” refers to a stationary game console, a portable game console, a wearable terminal, a desktop or laptop personal computer, a tablet computer, or a FDA and may be a portable terminal such as a smartphone including a touch panel sensor on a display screen. For example, the “server apparatus” refers to an apparatus that executes a process in accordance with a request from a terminal apparatus.

For example, the “three-dimensional virtual space” refers to a virtual space that is defined by three-dimensional axes on a computer. For example, the “image representing the progress status” refers to an image obtained by capturing an inside of the three-dimensional virtual space at a moment or in a time range within a predetermined virtual space, and is a concept also including an image generated based on the captured image. For example, the “viewpoint coordinates” refer to any coordinates as the viewpoint for generating the image representing the progress status of the video game. For example, the “viewpoint object” refers to an object that is present at coordinates corresponding to the viewpoint coordinates. For example, the “object” is an object arranged in the three-dimensional virtual space, and the object may be visible or invisible. The viewpoint object is a concept included in the object.

For example, the “sight line direction” refers to a visual axis direction of a virtual camera. For example, the “first attribute” refers to an attribute of the viewpoint object involved in generation of the image. For example, “independently of the instruction operation of the player” refers to irrelevance to an input signal caused by the player, and the input signal may be of any type.

### Second Embodiment

Next, a summary of a second embodiment of the present disclosure will be described. Hereinafter, as the second embodiment, the image generation program executed in the server apparatus of the image generation system that includes the client terminal and the server apparatus connectable to the client terminal by communication and generates the image representing the progress status of the video game which uses the three-dimensional virtual space will be illustratively described.

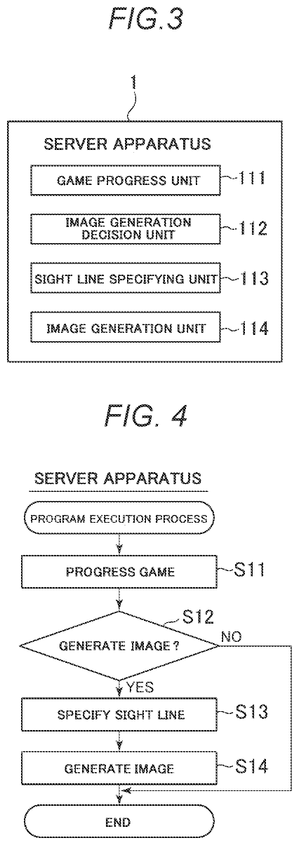

FIG. 3 is a block diagram illustrating a configuration of the server apparatus according to at least one embodiment of the present disclosure. The server apparatus 1 includes a game progress unit 111, an image generation decision unit 112, a sight line specifying unit 113, and an image generation unit 114.

The game progress unit 111 has a function of progressing the video game. The image generation decision unit 112 has a function of deciding whether or not to generate the image based on the first attribute and/or a second attribute of the viewpoint object.

The sight line specifying unit 113 has a function of specifying, using any viewpoint coordinates as the viewpoint for generating the image representing the progress status of the video game, the sight line direction of the viewpoint object that is the object corresponding to the viewpoint coordinates. The image generation unit 114 has a function of generating the image independently of the instruction operation of the player of the video game based on the sight line direction specified b the sight line specifying unit 113 and the first attribute of the viewpoint object.

Next, the program execution process in the second embodiment of the present disclosure will be described. FIG. 4 is a flowchart of the program execution process according to at least one embodiment of the present disclosure.

The server apparatus 1 progresses the video game (step S11). Next, the server apparatus 1 decides whether or not to generate the image based on the first attribute and/or the second attribute of the viewpoint object (step S12).

In a case of generating the image (YES in step S12), the server apparatus 1 specifies, using any viewpoint coordinates as the viewpoint for generating the image representing the progress status of the video game, the sight line direction of the viewpoint object that is the object corresponding to the viewpoint coordinates (step S13), Next, the server apparatus 1 generates the image independently of the instruction operation of the player of the video game based on the specified sight line direction and the first attribute of the viewpoint object (step S14) and finishes the process.

In a case of not generating the image (NO in step S12), the server apparatus 1 does not generate the image and finishes the process.

As one aspect of the second embodiment, a new image generation program of higher interest can be provided.

As one aspect of the second embodiment, by including the image generation decision unit, an image generation program of higher interest that can reflect a difference in attribute of the viewpoint object on image generation can be provided.

In the second embodiment, contents disclosed in the first embodiment can be employed as necessary for each of the “client terminal”, the “server apparatus”, the “three-dimensional virtual space”, the “image representing the progress status”, the “viewpoint coordinates”, the “viewpoint object”, the “object”, the “sight line direction”, the “first attribute”, and “independently of the instruction operation of the player”.

In the second embodiment, for example, the “second attribute” refers to an attribute of the viewpoint object different from the first attribute.

### Third Embodiment

Next, a summary of a third embodiment of the present disclosure will be described. Hereinafter, as the third embodiment, the image generation program executed in the server apparatus of the image generation system that includes the client terminal and the server apparatus connectable to the client terminal by communication and generates the image representing the progress status of the video game which uses the three-dimensional virtual space will be illustratively described.

Contents related to a server configuration in the first embodiment or the second embodiment can be employed as necessary for a configuration of the server apparatus in the third embodiment. Furthermore, contents related to the program execution process in the first embodiment or the second embodiment can be employed as necessary for a flowchart of the program execution process. The third embodiment is disclosed with reference to, but not limited to, the first embodiment,

In the third embodiment, it is preferable that a technical level for generating the image is set in the viewpoint object.

It is preferable that the image generation unit 103 generates the image corresponding to the technical level of the viewpoint object based on the sight line direction specified by the sight line specifying unit 102 and the first attribute of the viewpoint object.

As one aspect of the third embodiment, a new image generation program of higher interest can be provided.

As one aspect of the third embodiment, by generating the image corresponding to the technical level set in the viewpoint object, different images can be provided for each viewpoint object.

In the third embodiment, contents disclosed in the first embodiment can be employed as necessary for each of the “client terminal”, the “server apparatus”, the “three-dimensional virtual space”, the “image representing the progress status”, the “viewpoint coordinates”, the “viewpoint object”, the “object”, the “sight line direction”, the “first attribute”, and “independently of the instruction operation of the player”. Contents disclosed in the second embodiment can be employed as necessary for the “second attribute”.

In the third embodiment, for example, the “technical level” refers to a parameter set in the viewpoint object and is a parameter that contributes to generation of the image.

### Fourth Embodiment

Next, a summary of a fourth embodiment of the present disclosure will be described. Hereinafter, as the fourth embodiment, the image generation program executed in the server apparatus of the image generation system that includes the client terminal and the server apparatus connectable to the client terminal by communication and generates the image representing the progress status of the video game which uses the three-dimensional virtual space will be illustratively described. In addition, an image generation program that uses a genetic algorithm will be illustratively exemplified as the image generation program in the fourth embodiment of the present disclosure.

Various objects may be arranged in the three-dimensional virtual space. For example, the objects have attributes of a light source object, a landform object, a character object, a building object, a natural object, and the like. The viewpoint object that is the object corresponding to the viewpoint coordinates for generating the image refers to an object as the viewpoint coordinates among any objects.

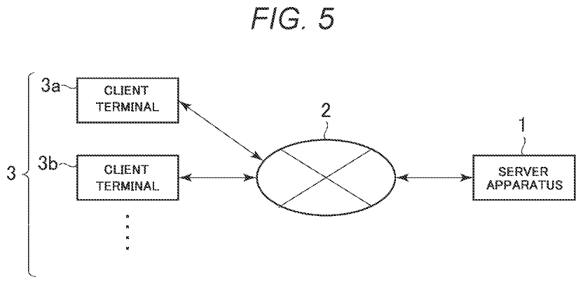

FIG. 5 is a block diagram illustrating a configuration of the system according to at least one embodiment of the present disclosure. As illustrated, the system is configured with a plurality of client terminals 3 (client terminals 3a, 3b, . . . ; hereinafter referred to as a terminal apparatus) operated by a plurality of players (players A, B,), a communication network 2, and the server apparatus 1. The terminal apparatus 3 is connected to the server apparatus 1 through the communication network 2. The terminal apparatus 3 and the server apparatus 1 may not be connected at all times, and the connection may be available as necessary.

The server apparatus 1 includes at least a control unit, a RAM, a storage unit, and a communication interface that are connected to each other through an internal bus. The control unit may include an internal timer. In addition, the control unit may synchronize with an external server using the communication interface. Accordingly, the real time may be acquired.

As one example, the terminal apparatus 3 includes a control unit, a RAM, a storage unit, a sound processing unit, a graphics processing unit, a communication interface, and an interface unit that are connected to each other through an internal bus. The graphics processing unit is connected to a display unit. The display unit may include a display screen and a touch input unit that receives an input by contact of a player on the display unit.

For example, the touch input unit may be able to detect a position of contact using any methods such as a resistive film method, an electrostatic capacitive method, an ultrasonic surface acoustic wave method, an optical method, or an electromagnetic induction method used in a touch panel, and any method may be used as long as an operation can be recognized by a touch operation of the player, The touch input unit is a device that can detect a position of a finger or the like in a case where an operation such as push or movement is performed on an upper surface of the touch input unit with the finger, a stylus, or the like.

An external memory (for example, an SD card) may be connected to the interface unit. Data read from the external memory is loaded into the RAM, and an operation process is executed on the data by the control unit.

The communication interface can be connected to the communication network in a wireless or wired manner and can receive data through the communication network. In the same manner as the data read from the external memory, data received through the communication interface is loaded into the RAM, and the operation process is performed on the data by the control unit.

The terminal apparatus 3 may include a sensor such as a proximity sensor, an infrared sensor, a gyro sensor, or an acceleration sensor. In addition, the terminal apparatus 3 may include an imaging unit that includes a lens and performs imaging through the lens. Furthermore, the terminal apparatus 3 may be a terminal apparatus that can be mounted (wearable) on a human body.

### Summary of System

Next, a summary of the system assumed in the fourth embodiment of the present disclosure will be described. In the fourth embodiment, the image generation system (hereinafter, referred to as the system) including one or more client terminals operated by the player and the server apparatus connectable to the client terminal by communication will be described. As one example of the image generation system, a game system related to an RPG in which an object (hereinafter, referred to as a player object) that acts in accordance with an operation instruction of the player can move in the three-dimensional virtual space is exemplified.

The player object can form a party with another player object that acts in accordance with another player, or an NPC object that is controlled by the server apparatus or the client terminal. Hereinafter, in the fourth embodiment of the present disclosure, a game system that captures a photo of the image of the inside of the three-dimensional virtual space viewed from the NRC object (hereinafter, referred to as a viewpoint object) which acts together with the player object will be described as one example.

### Functional Description

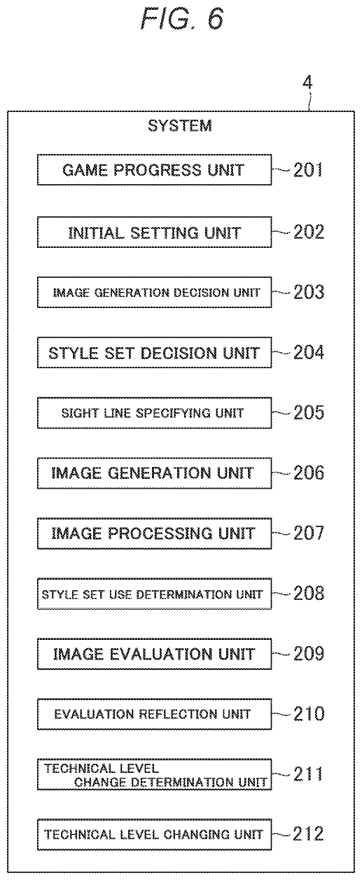

Functions of a system 4 will be described, FIG. 6 is a block diagram illustrating a configuration of the system according to at least one embodiment of the present disclosure.

The system 4 may include a game progress unit 201, an initial setting unit 202, an image generation decision unit 203, a style set decision unit 204, a sight line specifying unit 205, an image generation unit 206, an image processing unit 207, a style set use determination unit 208, an image evaluation unit 209, an evaluation reflection unit 210, a technical level change determination unit 211, and a technical level changing unit 212.

The game progress unit 201 has a function of progressing the video game. The initial setting unit 202 has a function of setting a plurality of style sets to be applied in generation of the image. The image generation decision unit 203 has a function of deciding whether or not to generate the image based on the first attribute and/or the second attribute of the viewpoint object. The style set decision unit 204 has a function of deciding a style set to be used for generating the image.

The sight line specifying unit 205 has a function of specifying, using any viewpoint coordinates as the viewpoint for generating the image representing the progress status of the video game, the sight line direction of the viewpoint object that is the object corresponding to the viewpoint coordinates. The image generation unit 206 has a function of generating the image independently of the instruction operation of the player of the video game based on the specified sight line direction and the first attribute of the viewpoint object. The image processing unit 207 has a function of processing the image generated by the image generation unit 206 based on the first attribute of the object.

The style set use determination unit 208 has a function of determining whether or not all style sets set to be used in the image generation have been used. The image evaluation unit 209 has a function of receiving an evaluation of the image generated by the image generation unit 206 or processed by the image processing unit 207. The evaluation reflection unit 210 has a function of reflecting the evaluation received by the image evaluation unit 209 on a style set to be applied in the subsequent image generation.

The technical level change determination unit 211 has a function of determining whether or not a condition for changing the technical level is satisfied. The technical level changing unit 212 has a function of changing the technical level in a case where the technical level change determination unit 211 determines that the condition for changing the technical level is satisfied.

### Execution Process Flow

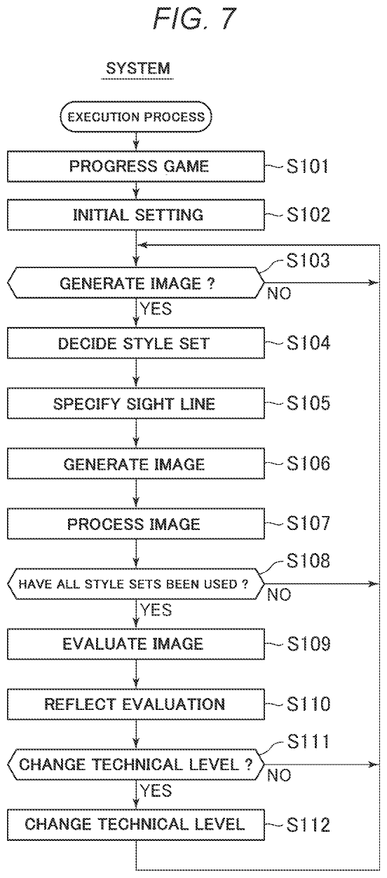

In the fourth embodiment of the present disclosure, the execution process that uses the genetic algorithm is performed as one example. FIG. 7 is a flowchart related to the execution process according to at least one embodiment of the present disclosure.

The system 4 progresses the video game (step S101). Next, the system 4 sets the plurality of style sets to be applied in generation of the image as initial setting (step S102).

### Style Set

In the fourth embodiment of the present disclosure, a collection of attribute values (options) referred to as the style set is used in generation of the image. The style set corresponds to an individual of the genetic algorithm, and the attribute values set in the style set correspond to genes. At least one style set may be set for each viewpoint object.

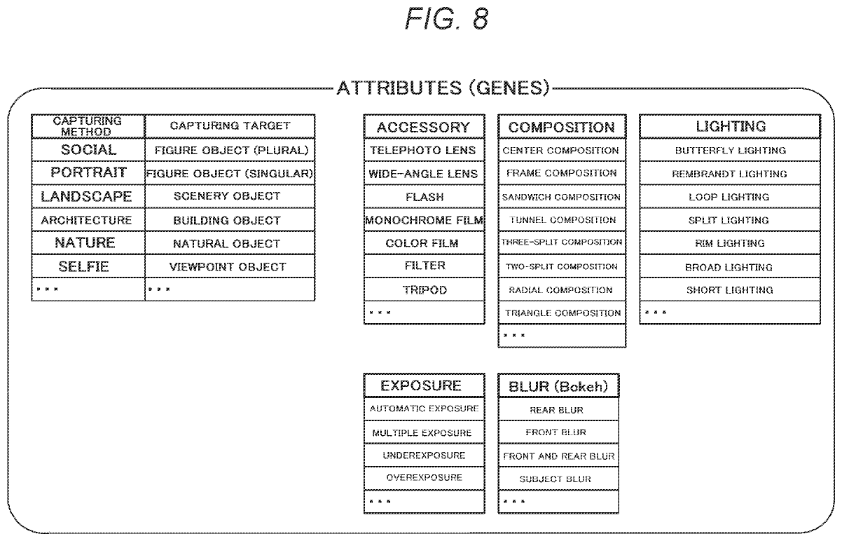

FIG. 8 is a diagram for describing attributes according to at least one embodiment of the present disclosure. As one example of the attributes, a capturing method (social, portrait, landscape, architecture, nature, selfie, and the like), an accessory, a composition, lighting, exposure, blur, and the like are exemplified. A target object (target) of capturing may be set for each capturing method.

One or more of the other attributes other than the capturing method may be set for each capturing method. All attributes may be set in the capturing method, or attributes that are not applied may not be set in the capturing method. In addition, the number of other set attributes may be changed in accordance with the technical level described later.

That is, for example, the attributes illustrated in FIG. 8 are options of how to perform capturing, options of used equipment, and options of setting (exposure and the like) of a camera, and a collection of options is referred to as the style set.

The flow in FIG. 7 will be described again. In step S102, the system 4 sets the number (for example, 10) of generated images in advance as the initial setting. The system 4 randomly generates style sets corresponding to the number of generated images. The plurality of style sets initially set by the system 4 may be a random combination of the attributes illustrated in FIG. 8.

Next, the system 4 decides whether or not to generate the image based on a style set (first attribute) of the viewpoint object and/or a personality (second attribute) of the viewpoint object (step S103). The “personality” of the viewpoint object may be set in advance in the viewpoint object as an attribute.

For example, short-temperedness, stingyness, meticulousness, and carefreeness are exemplified as the personality of the viewpoint object. A period in which whether or not to capture the photo is decided may vary for each personality. For example, the viewpoint object having the personality “short-temperedness” decides to perform capturing as soon as the viewpoint object encounters a scene in which a photo complying with the style set can be captured. Meanwhile, the viewpoint object having the personality “carefreeness” may miss a good opportunity of capturing even in a case where the viewpoint object encounters the scene in which the photo complying with the style set can be captured. Alternatively, in a case where a cost in in-game currency or the like is incurred in generation of the image, the viewpoint object having the personality “stingyness” may hesitate to capture the photo. In such a manner, whether or not to generate the image is decided by considering the style set and the personality of the viewpoint object.

In a case of generating the image (YES in step S103), the system 4 decides the style set for generating the image (step S104). The style set may be selected from the plurality of style sets set in step 5102 only for the first time, and for the second time or later, may be selected from the plurality of style sets on which the evaluation of the image described later is reflected. In a case of not generating the image (NO in step S103), step S103 is executed again at a predetermined timing.

Next, the system 4 specifies the sight line based on the style set decided in step S104 (step S105). At this point, the coordinates as the viewpoint are decided based on a position (for example, position coordinates of an eye portion) of the viewpoint object. That is, position coordinates to which the viewpoint object can move may be the viewpoint coordinates.

The viewpoint coordinates may be decided based on a trigger caused by an event or may be decided after searching for whether or not an image complying with the capturing target of the capturing method included in the style set can be captured from the position coordinates of the viewpoint object for each predetermined timing.

In step S105, the sight line may be specified based on not only the viewpoint coordinates and the style set but also the technical level described later. The technical level is an attribute that may be set in the viewpoint object, and may be an attribute that is not tied to the style set.

A method of deciding a composition of the photo may be changed in accordance with the technical level. For example, a case where the capturing method is “portrait” will be described. In a case where the technical level is low, a ratio at which a figure object of the capturing target is included in the image is increased, and an awkward image may be generated. Meanwhile, in a case where the technical level is high, an appropriate image in which the ratio of the figure object of the capturing target and a surrounding space are balanced may be generated. In such a manner, master data in which the ratio of the capturing target is defined may be set in advance in accordance with the technical level. Furthermore, the ratio determined by the master data may be changed based on the evaluation described later.

Next, the system 4 generates the image independently of the instruction operation of the player of the video game based on the specified sight line direction and the style set (first attribute) of the viewpoint object (step S106). Generation of the image is performed by rendering from scene layout setting constituting the three-dimensional virtual space.

Next, the system 4 processes the image generated in step S106 based on the style set (first attribute) of the viewpoint object (step S107). For example, a case where a “filter” or a “monochrome film” is employed in the “accessory” that is one of the attributes is exemplified as processing based on the style set. By processing the image, a tone or brightness of the generated image can be adjusted, and individuality of the viewpoint object can be represented.

In processing of the image, it is preferable that the image is processed based on information constituting the three-dimensional virtual space. By using configuration information about the three-dimensional virtual space, for example, the image can be processed by considering information related to depth.

Next, the system 4 determines whether or not all of the plurality of style sets prepared for the image generation have been used (step S108). In a case where not all of the style sets are used (NO in step S108), a return is made to step S103 again, and the process continues.

In a case where generation of the expected number of images is finished (YES in step S108), the system 4 receives evaluations of the generated images (step S109). The evaluations may be evaluations from the player who plays the game, or may be evaluations from the NPC object different from the viewpoint object. It is preferable that evaluation is performed on all images generated in step S106.

Next, the system 4 reflects the evaluations received by the image evaluation unit 209 in step S109 on the style sets applicable to the subsequent image generation (step S110).

### Reflection of Evaluation on Style Set

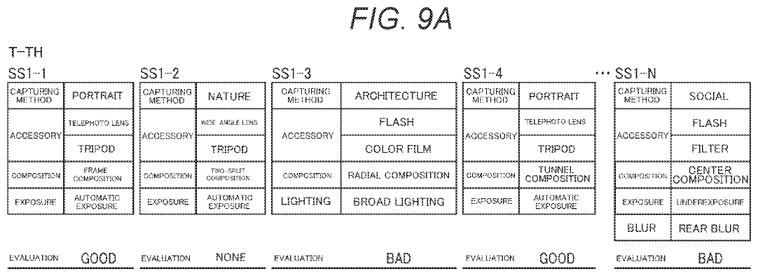

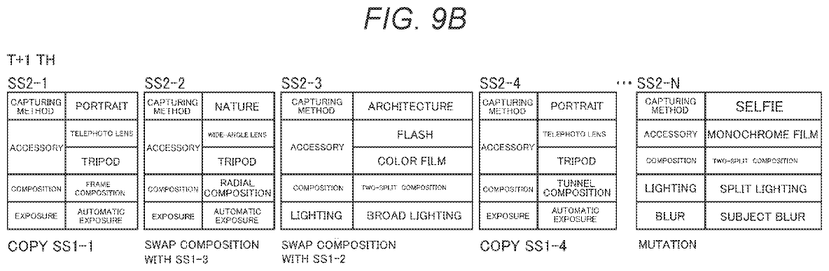

A process of reflecting the evaluation on the style set applicable to the subsequent image generation will be described. FIGS. 9A and 9B are diagram for describing a process of updating the style sets according to at least one embodiment of the present disclosure. FIG. 9A represents contents of a plurality of style sets SS1-1 to SS1-N (N is a natural number greater than or equal to 5) in T-th (T is a natural number) image generation and the evaluations of the images generated based on the style sets. FIG. 9B represents contents of a plurality of style sets SS2-1 to SS2-N in T+1-th image generation.

The style sets “SS1-1” and “SS1-4” for which an evaluation “GOOD” is received are employed (selected) as T+1-th style sets. The remaining style sets are either not evaluated or have an evaluation “BAD”. Thus, it is preferable to change the attributes and use the style sets as the T+1-th style sets.

Therefore, the attributes included in the style sets are changed by performing crossover or mutation for changing the attributes.

First, the mutation will be described. For the remaining style sets, a style set (in the drawing, the style set SS1-N) in which the mutation occurs is decided using a given probability of occurrence of the mutation. Next, one or more attribute values of the style set corresponding to the mutation are randomly changed.

Next, the crossover will be described. The attribute value is swapped between two style sets that are not selected or in which the mutation does not occur. In the drawing, the attribute value “composition” is exchanged between SS1-2 and SS1-3, and exchanged SS1-2 and SS1-3 are set as the T+1-th style sets as SS2-2 and SS2-3, respectively.

In such a manner, by causing the style set with which an image having a good evaluation is generated to remain in the next generation and changing the attribute value for the style set with which an image not having a good evaluation is generated, the original style set can be changed to a different style set, and the number of style sets with which an image having a good evaluation is generated can be increased. An image preferred by the player, the NPC, or the like performing the evaluation can be generated. Setting of the crossover and the mutation is not limited to the above method and may be appropriately decided by those skilled in the art. For example, the crossover may be set to be performed between style sets having the evaluation GOOD. By doing so, a system of dominant inheritance in which a style set having a bad evaluation is weeded out, and a style set having a good evaluation survives can be constructed.

In addition, reflection of the evaluations may be implemented using a method that does not use the genetic algorithm. For example, the evaluations received in step S109 are reflected on the attributes (options), and an evaluation value is calculated using a predetermined evaluation function that takes each option as an input parameter. A style set having an attribute group of which the calculated evaluation value is high may be employed. Alternatively, after calculating the evaluation value for all options, an approximate value indicating how an option having a high evaluation value and an option usable by the viewpoint object are approximate may be calculated, and an option having a high approximate value (similar) may be employed.

The flow in FIG. 7 will be described again. Next, the system 4 determines whether or not the condition for changing the technical level is satisfied (step S111). For example, the condition for changing the technical level is exemplified such that a predetermined number of images are generated, a cumulative number of times good evaluations are received exceeds a predetermined value, good evaluations with respect to the images generated using the plurality of style sets for generating the image exceed a predetermined ratio (example: out of 10 generated images, 7 or 70% or more have the evaluation GOOD). Alternatively, a case where a cumulative number of times bad evaluations are received exceeds a predetermined value, or a case where bad evaluations exceed a predetermined ratio may be available.

In a case where the condition is satisfied in step S111 (YES in step S111), the system 4 changes the technical level of the target viewpoint object (step S112). A return is made to the process of step S103, and generation of the image further continues using new style sets on which the evaluations in step S109 are reflected. In a case where the condition is not satisfied in step S111 (NO in step Sill), the system 4 returns to the process of step S103 and repeatedly executes the image generation. For example, a pause or a finish of the game is exemplified as a condition for finishing the execution process.

In the above example, while the genetic algorithm is used for deciding the style set, the embodiment of the present disclosure is not limited thereto. For example, a predetermined evaluation value may be calculated for all style sets, and a style set having the highest evaluation value may be employed. Alternatively, after calculating the evaluation value for all style sets, an approximate value indicating how a style set having a high evaluation value and a style set usable by the viewpoint object are approximate may be calculated, and a style set having a high approximate value (similar) may be employed.

In the above example, while the sight line is specified based on the style set, the embodiment of the present disclosure is not limited thereto. For example, the sight line may be aligned to any direction, and then, the style set may be applied.

in the above example, while the technical level is described as an attribute that may be set for each viewpoint object, the embodiment of the present disclosure is not limited thereto. For example, the technical level may be set for each style set or each attribute such as the capturing method.

In the above example, while the server apparatus is used, the embodiment of the present disclosure is not limited thereto. For example, instead of a storage of the server apparatus, a distributed ledger used in the blockchain technology may be used.

In the above example, while the process is executed in the system, the embodiment of the present disclosure is not limited thereto. For example, design may be appropriately changed such that the server apparatus or the client apparatus executes the process.

In the above example, while a game program is exemplified, the embodiment of the present disclosure is not limited thereto. For example, the present embodiment may be applied to a program for capturing the photo in a real space using AI.

As one aspect of the fourth embodiment, a new image generation system of higher interest can be provided.

As one aspect of the fourth embodiment, by including the image generation decision unit, an image generation system of higher interest that can reflect a difference in attribute of the viewpoint object on the image generation can be provided.

As one aspect of the fourth embodiment, by generating the image corresponding to the technical level set in the viewpoint object, different images can be provided for each viewpoint object.

As one aspect of the fourth embodiment, by setting the technical level in each viewpoint object, two axes of a style and the technical level can be used as elements involved in the image generation, and a more complex image generation system of higher interest can be provided.

As one aspect of the fourth embodiment, by including the image evaluation unit and the technical level changing unit, the evaluation with respect to the image can be reflected on the technical level and consequently, reflected on the image generation, and a dynamic image generation system of higher interest can be provided.

As one aspect of the fourth embodiment, by including the image processing unit, the number of variations of images that can be generated can be increased, and an image generation system of higher interest can be provided.

As one aspect of the fourth embodiment, by causing the image processing unit to process the image based on the information constituting the three-dimensional virtual space, the image can be processed using more information, and a more attractive image can be generated.

In the fourth embodiment, contents disclosed in the first embodiment can be employed as necessary for each of the “client terminal”, the “server apparatus”, the “three-dimensional virtual space”, the “image representing the progress status”, the “viewpoint coordinates”, the “viewpoint object”, the “object”, the “sight line direction”, the “first attribute”, and “independently of the instruction operation of the player”. Contents disclosed in the second embodiment can be employed as necessary for the “second attribute”. Contents disclosed in the third embodiment can be employed as necessary for the “ technical level”.

In the fourth embodiment, for example, the “information constituting the three-dimensional virtual space” refers to information that is defined for generating the three-dimensional virtual space and is, more specifically, exemplified by positional information about a light source and information related to depth and material. For example, the “style set” refers to a collection of attributes (options) used for generating the image.

### Fifth Embodiment

A summary of a fifth embodiment of the present disclosure will be described. Hereinafter, as the fifth embodiment, the image generation program executed in the server apparatus of the image generation system that includes the client terminal and the server apparatus connectable to the client terminal by communication and generates the image representing the progress status of the video game which uses the three-dimensional virtual space will be illustratively described. In addition, the image generation program that uses the genetic algorithm will be illustratively exemplified as the image generation program in the fifth embodiment of the present disclosure.

Various objects may be arranged in the three-dimensional virtual space. For example, the objects have the attributes of the light source object, the landform object, the character object, the building object, the natural object, and the like. The viewpoint object that is the object corresponding to the viewpoint coordinates for generating the image refers to the object as the viewpoint coordinates among any objects.

The configuration illustrated in FIG. 5 can be employed as necessary for a configuration of the system in the fifth embodiment of the present disclosure. The configurations illustrated in the fourth embodiment can be employed as necessary for configurations of the server apparatus and the client terminal in the fifth embodiment of the present disclosure,

### System Summary

Next, a summary of the system assumed in the fifth embodiment of the present disclosure will be described. In the fifth embodiment, the image generation system (hereinafter, referred to as the system) including one or more client terminals operated by the player and the server apparatus connectable to the client terminal by communication will be described. As one example of the image generation system, the game system related to the RPG in which the object (hereinafter, referred to as the player object) that acts in accordance with the operation instruction of the player can move in the three-dimensional virtual space is exemplified.

The player object can form a party with another player object that acts in accordance with another player, or the NPC object that is controlled by the server apparatus or the client terminal. Hereinafter, in the fifth embodiment of the present disclosure, a game system in which the image of the inside of the three-dimensional virtual space viewed from the NPC object (hereinafter, referred to as the viewpoint object) which acts together with the player object is depicted as a painting by the viewpoint object will be described as one example.

### Functional Description

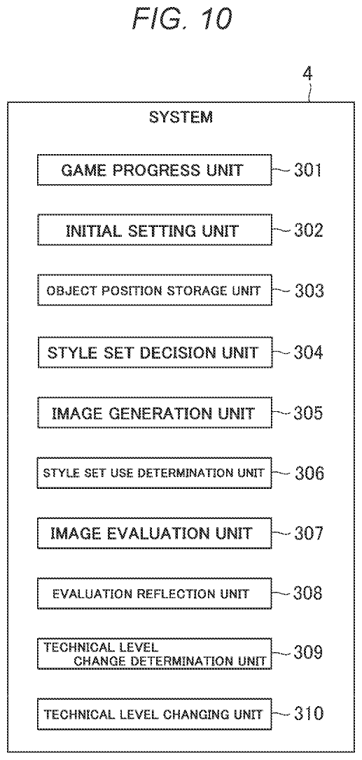

Functions of the system 4 will be described. FIG. 10 is a block diagram illustrating a configuration of the system according to at least one embodiment of the present disclosure.

The system 4 may include a game progress unit 301, an initial setting unit 302, an object position storage unit 303, a style set decision unit 304, an image generation unit 305, a style set use determination unit 306, an image evaluation unit 307, an evaluation reflection unit 308, a technical level change determination unit 309, and a technical level changing unit 310.

The game progress unit 301 has a function of progressing the video game. The initial setting unit 302 has a function of setting the plurality of style sets to be applied in generation of the image. The object position storage unit 303 has a function of storing a position of an object, in the three-dimensional virtual space, that can be visually recognized by the virtual camera from any viewpoint coordinates at a predetermined timing in the video game.

The style set decision unit 304 has a function of deciding the style set to be used for generating the image, The image generation unit 305 has a function of generating a new image independently of the instruction operation of the player of the video game based on the position of the object stored in the object position storage unit 303. The image in the fifth embodiment of the present disclosure is not limited to an image corresponding to the photo described in the fourth embodiment and may be, for example, an image of a tool, an article, a person, a sculpture, or a painting.

The style set use determination unit 306 has a function of determining whether or not all style sets set by the initial setting unit 302 have been used. The image evaluation unit 307 has a function of receiving an evaluation of the image generated by the image generation unit 305.

The evaluation reflection unit 308 has a function of reflecting the evaluation received by the image evaluation unit 307 on the style set applicable in the subsequent image generation. The technical level change determination unit 309 has a function of determining whether or not the condition for changing the technical level is satisfied. The technical level changing unit 310 has a function of changing the technical level in a case where the technical level change determination unit 309 determines that the condition for changing the technical level is satisfied.

### Execution Process Flow

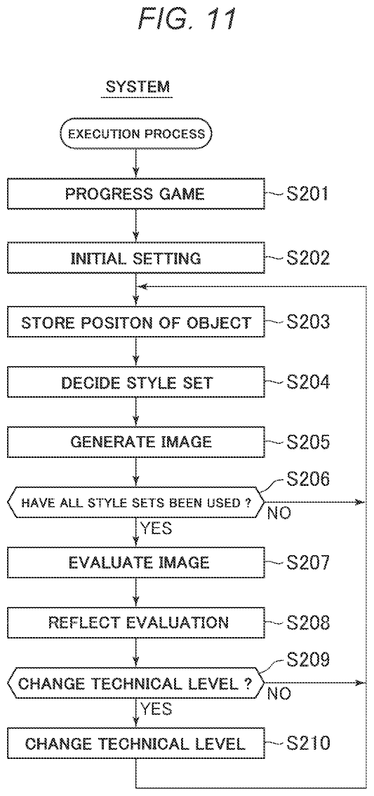

In the fifth embodiment of the present disclosure, the execution process that uses the genetic algorithm is performed as one example. FIG. 11 is a flowchart related to the execution process according to at least one embodiment of the present disclosure.

The system 4 progresses the video game (step S201). Next, the system 4 sets the plurality of style sets to be applied in generation of the image as initial setting (step S202).

### Style Set

In the fifth embodiment of the present disclosure, a collection of attribute values (options) referred to as the style set is used in generation of the image. The style set corresponds to an individual of the genetic algorithm, and the attribute values set in the style set correspond to genes. At least one style set may be set for each viewpoint object.

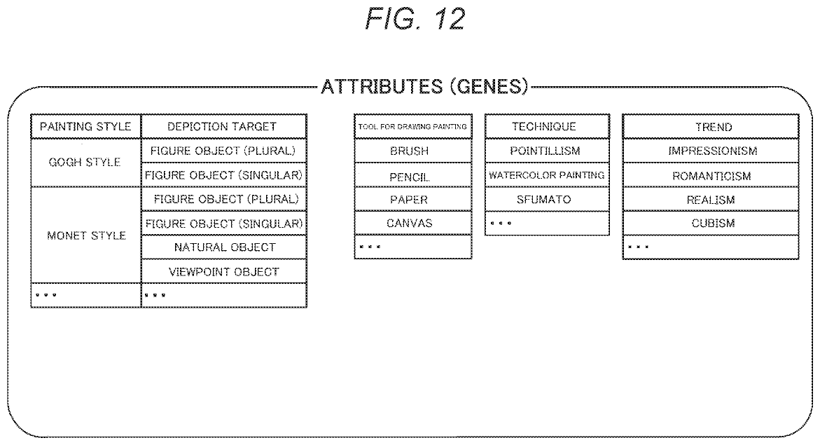

FIG. 12 is a diagram for describing the attributes according to at least one embodiment of the present disclosure. As one example of the attributes, a painting style (Gogh style, Monet style, and the like), a tool (a brush, a pencil, paper, a canvas, and the like) for drawing a painting, a technique (pointillism, watercolor painting, sfumato, and the like), a trend (impressionism, romanticism, realism, Cubism, and the like) are exemplified. A target object (target) to be drawn may be set for each painting style.

One or more of the other attributes other than the painting style may be set for each painting style. All attributes may be set in the painting style, or attributes that are not applied may not be set in the painting style. In addition, the number of other set attributes may be changed in accordance with the technical level described later.

That is, for example, the attributes illustrated in FIG. 12 are options of the painting style, options of the tool, and options of the technique, and a collection of options is referred to as the style set.

The flow in FIG. 11 will be described again. In step S202, the system 4 sets the number (for example, 10) of generated images in advance as the initial setting. The system 4 generates style sets corresponding to the number of generated images. The plurality of style sets initially set by the system 4 may be a random combination of the attribute values illustrated in FIG. 12.

Next, the system 4 stores the position of the object, in the three-dimensional virtual space, that can be visually recognized by the virtual camera from any viewpoint coordinates at the predetermined timing in the video game (step S203). At this point, the viewpoint coordinates are decided based on the position (for example, the position coordinates of the eye portion) of the viewpoint object. That is, position coordinates to which the viewpoint object can move may be the viewpoint coordinates.

Next, the system 4 decides the style set for generating the image (step S204). The style set may be selected from the plurality of style sets set in step S202 only for the first time, and for the second time or later, may be selected from the plurality of style sets on which the evaluation of the image described later is reflected.

Next, the system 4 generates the image independently of the instruction operation of the player of the video game based on positional information about the object stored in step S203 and the style set (the first attribute of the viewpoint object) decided in step S204 (step S205). Generation of the image is performed by rendering from the scene layout setting constituting the three-dimensional virtual space.

In generation of the image, the style set in step S204 may be decided in accordance with the technical level described later. For example, a case where a depiction target is the “figure object (singular)” will be described. In a case where the technical level is low, a ratio at which the figure object as one motif is included in the image (painting) is increased, and an awkward image (painting) may be generated. Meanwhile, in a case where the technical level is high, an appropriate image (painting) in which the ratio of the figure object as one motif and the surrounding space are balanced may be generated. In such a manner, the master data in which the ratio of the motif is defined may be set in advance in accordance with the technical level. Furthermore, the ratio determined by the master data may be changed based on the evaluation described later.

In generation of the image, it is preferable that the image is generated based on the information constituting the three-dimensional virtual space, By generating the image by considering the configuration information about the three-dimensional virtual space, for example, the information related to depth, a more complex image than in a case of converting two-dimensional image data can be generated.

For example, the image may be generated based on the motif of the object arranged in the three-dimensional virtual space. At this point, an effect or a color of the light source object may not be considered in the motif of the object. Alternatively, for example, generation of the image may be such that a new image is generated by processing the image obtained by imaging the inside of the three-dimensional virtual space in accordance with a predetermined rule. That is, the image representing the three-dimensional virtual space may be initially generated, and the generated image may be processed in accordance with the style set of the viewpoint object.

Next, the system 4 determines whether or not all of the plurality of style sets prepared for the image generation have been used (step S206). In a case where not all of the style sets are used (NO in step S206), a return is made to step S203 again, and the process continues.

In a case where generation of the expected number of images is finished (YES in step S206), the system 4 receives evaluations of the generated images (step S207). The evaluations may be evaluations from the player who plays the game, or may be evaluations from the NPC object different from the viewpoint object. It is preferable that evaluation is performed on all generated images.

Next, the system 4 reflects the evaluations received by the image evaluation unit 307 in step S207 on the style sets applicable to the subsequent image generation (step S208). Contents related to reflection of the evaluation on the style set in the fourth embodiment and contents in FIGS. 9A and 9B can be employed as necessary for reflection of the evaluation on the style set in the fifth embodiment.

Next, the system 4 determines whether or not the condition for changing the technical level is satisfied (step S209). For example, the condition for changing the technical level is exemplified such that a predetermined number of images are generated, a cumulative number of times good evaluations are received exceeds a predetermined value, good evaluations with respect to the images generated using the plurality of style sets for generating the image exceed a predetermined ratio (example: out of 10 generated images, 7 or 70% or more have the evaluation GOOD). Alternatively, a case where a cumulative number of times bad evaluations are received exceeds a predetermined value, or a case where bad evaluations exceed a predetermined ratio may be available.

In a case where the condition is satisfied in step S209 (YES in step S209), the system 4 changes the technical level of the target viewpoint object (step S210). The image is repeatedly generated using new style sets. The pause or the finish of the game is exemplified as the condition for finishing the execution process. In a case where the condition is not satisfied in step S209 (NO in step S209), the system 4 returns to the process of step S203 and repeatedly executes the image generation. For example, the pause or the finish of the game is exemplified as the condition for finishing the execution process.

In the above example, while the genetic algorithm is used for deciding the style set, the embodiment of the present disclosure is not limited thereto. For example, a predetermined evaluation value may be calculated for all style sets, and a style set having the highest evaluation value may be employed. Alternatively, after calculating the evaluation value for all style sets, an approximate value indicating how a style set having a high evaluation value and a style set usable by the viewpoint object are approximate may be calculated, and a style set having a high approximate value (similar) may be employed.

In the above example, while an example of not processing the image is described, the embodiment of the present disclosure is not limited thereto. For example, the generated image may be processed such that a shape of a view frustum (drawing region) of rendering is distorted in accordance with the technical level.

In the above example, while the sight line is not particularly mentioned, the image may be generated for each of both of left and right eyes.

In the above example, while the technical level is described as an attribute that may be set for each viewpoint object, the embodiment of the present disclosure is not limited thereto, For example, the technical level may be set for each style set or each attribute such as the capturing method.

In the above example, while the server apparatus is used, the embodiment of the present disclosure is not limited thereto. For example, instead of a storage of the server apparatus, a distributed ledger used in the blockchain technology may be used.

In the above example, while the process is executed in the system, the embodiment of the present disclosure is not limited thereto. For example, design may be appropriately changed such that the server apparatus or the client apparatus executes the process.

In the above example, while the game program is exemplified, the embodiment of the present disclosure is not limited thereto. For example, the present embodiment may be applied to a program for depicting a painting in the real space using AI.

As one aspect of the fifth embodiment, a new image generation system of higher interest can be provided.

As one aspect of the fifth embodiment, by generating the image corresponding to the technical level set in the viewpoint object, different images can be provided for each viewpoint object.

As one aspect of the fifth embodiment, by setting the technical level in each viewpoint object, two axes of the style and the technical level can be used as elements involved in the image generation, and a more complex image generation system of higher interest can be provided.

As one aspect of the fifth embodiment, by including the image evaluation unit and the technical level changing unit, the evaluation with respect to the image can be reflected on the technical level and consequently, reflected on the image generation, and a dynamic image generation system of higher interest can be provided.

As one aspect of the fifth embodiment, by causing the image generation unit to generate the image based on the information constituting the three-dimensional virtual space, the image can be generated using more information, and a more attractive image can be generated.

In the fifth embodiment, contents disclosed in the first embodiment can be employed as necessary for each of the “client terminal”, the “server apparatus”, the “three-dimensional virtual space”, the “viewpoint coordinates”, the “viewpoint object”, the “object”, the “sight line direction”, the “first attribute”, and “independently of the instruction operation of the player”. Contents disclosed in the second embodiment can be employed as necessary for the “second attribute”. Contents disclosed in the third embodiment can be employed as necessary for the “technical level”. Contents disclosed in the fourth embodiment can be employed as necessary for each of the “information constituting the three-dimensional virtual space” and the “style set”.

In the fifth embodiment, for example, the “image representing the progress status” refers to an image with which a content of the game can be understood, and is a concept including an image of a painting style.

### Sixth Embodiment

A summary of a sixth embodiment of the present disclosure will be described. Hereinafter, as the sixth embodiment, an image generation program executed in a computer apparatus generates an image representing a progress status of a video game which uses a three-dimensional virtual space will be illustratively described.

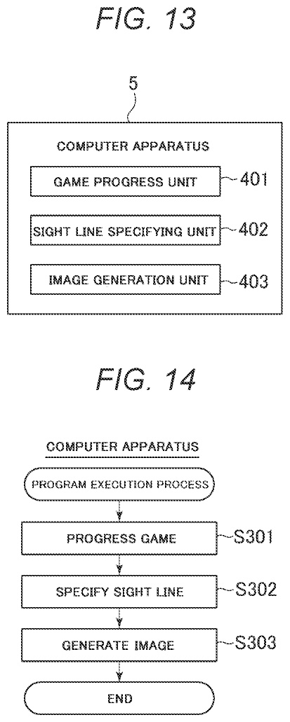

FIG. 13 is a block diagram illustrating a configuration of the computer apparatus according to at least one embodiment of the present disclosure. A computer apparatus 5 includes at least a game progress unit 401, a sight line specifying unit 402, and an image generation unit 403.

The game progress unit 401 has a function of progressing the video game. The sight line specifying unit 402 has a function of specifying, using any viewpoint coordinates as a viewpoint for generating the image representing the progress status of the video game, a sight line direction of a viewpoint object that is an object corresponding to the viewpoint coordinates. The image generation unit 403 has a function of generating the image independently of an instruction operation of a player of the video game based on the sight line direction specified by the sight line specifying unit 402 and a first attribute of the viewpoint object.

Next, a program execution process in the sixth embodiment of the present disclosure will be described. FIG. 14 is a flowchart of the program execution process according to at least one embodiment of the present disclosure.

The computer apparatus 5 progresses the video game (step S301). Next, the computer apparatus 5 specifies, using any viewpoint coordinates as the viewpoint for generating the image representing the progress status of the video game, the sight line direction of the viewpoint object that is the object corresponding to the viewpoint coordinates (step S302). Next, the computer apparatus 5 generates the image independently of the instruction operation of the player of the video game based on the specified sight line direction and the first attribute of the viewpoint object (step 3303) and finishes the process.

As one aspect of the sixth embodiment, a new image generation program of higher interest can be provided.

In the sixth embodiment, contents disclosed in the first embodiment can be employed as necessary for each of the “three-dimensional virtual space”, the “image representing the progress status”, the “viewpoint coordinates”, the “viewpoint object”, the “object”, the “sight line direction”, the “first attribute”, and “independently of the instruction operation of the player”.

In a sixth embodiment, for example, a “computer apparatus” refers to a stationary game console, a portable game console, a wearable terminal, a desktop or laptop personal computer, a tablet computer, or a PDA and may be a portable terminal such as a smartphone including a touch panel sensor on a display screen.

### Seventh Embodiment

Next, a summary of a seventh embodiment of the present disclosure will be described. Hereinafter, the image generation program for generating the image representing the progress status of the video game which uses the three-dimensional virtual space in the computer apparatus operated by one or more players will be illustratively described as the seventh embodiment. In addition, the image generation program that uses the genetic algorithm will be illustratively exemplified as the image generation program in the seventh embodiment of the present disclosure.

Various objects may be arranged in the three-dimensional virtual space. For example, the objects have the attributes of the light source object, the landform object, the character object, the budding object, the natural object, and the like. The viewpoint object that is the object corresponding to the viewpoint coordinates for generating the image refers to an object as the viewpoint coordinates among any objects.

The configuration of the client terminal illustrated in the fourth embodiment can be employed as necessary for a configuration of the computer apparatus in the seventh embodiment of the present disclosure.

### System Summary

Next, a summary of the system assumed in the seventh embodiment of the present disclosure will be described. In the seventh embodiment, the image generation program for generating the image representing the progress status of the video game which uses the three-dimensional virtual space in the computer apparatus operated by one or more players will be illustratively described. As one example of the video game, the RPG in which the object (hereinafter, referred to as the player object) that acts in accordance with the operation instruction of the player can move in the three-dimensional virtual space is exemplified.

The player object can form a party with the NPC object controlled by the computer apparatus. Hereinafter, in the seventh embodiment of the present disclosure, the game system that captures the photo of the image of the inside of the three-dimensional virtual space viewed from the NPC object (hereinafter, referred to as the viewpoint object) which acts together with the player object will be described as one example.

### Functional Description

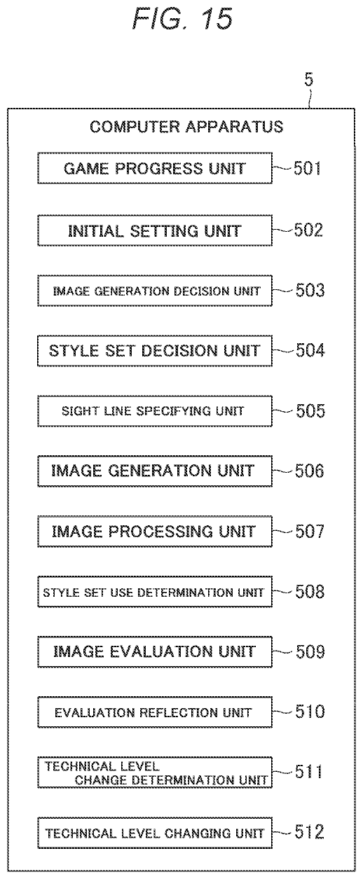

Functions of a computer apparatus 5 will be described. FIG. 15 is a block diagram illustrating a configuration of the system according to at least one embodiment of the present disclosure.

The computer apparatus 5 may include a game progress unit 501, an initial setting unit 502, an image generation decision unit 503, a style set decision unit 504, a sight line specifying unit 505, an image generation unit 506, an image processing unit 507, a style set use determination unit 508, an image evaluation unit 509, an evaluation reflection unit 510, a technical level change determination unit 511, and a technical level changing unit 512.

The game progress unit 501 has a function of progressing the video game. The initial setting unit 502 has a function of setting the plurality of style sets to be applied in generation of the image. The image generation decision unit 503 has a function of deciding whether or not to generate the image based on the first attribute and/or the second attribute of the viewpoint object. The style set decision unit 504 has a function of deciding the style set to be used for generating the image.

The sight line specifying unit 505 has a function of specifying, using any viewpoint coordinates as the viewpoint for generating the image representing the progress status of the video game, the sight line direction of the viewpoint object that is the object corresponding to the viewpoint coordinates. The image generation unit 506 has a function of generating the image independently of the instruction operation of the player of the video game based on the specified sight line direction and the first attribute of the viewpoint object. The image processing unit 507 has a function of processing the image generated by the image generation unit 506 based on the first attribute of the object.

The style set use determination unit 508 has a function of determining whether or not all style sets set by the initial setting unit 502 have been used. The image evaluation unit 509 has a function of receiving an evaluation of the image generated by the image generation unit 506 or processed by the image processing unit 507. The evaluation reflection unit 510 has a function of reflecting the evaluation received by the image evaluation unit 509 on the style set applicable in the subsequent image generation.

The technical level change determination unit 511 has a function of determining whether or not the condition for changing the technical level is satisfied. The technical level changing unit 512 has a function of changing the technical level in a case where the technical level change determination unit 511 determines that the condition for changing the technical level is satisfied.

### Execution Process Flow

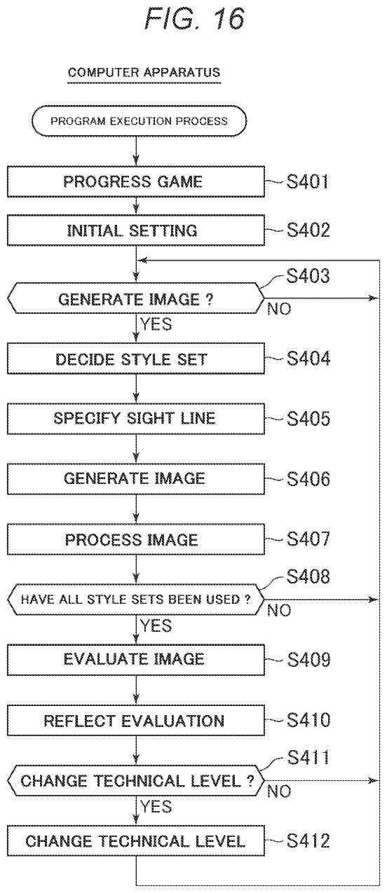

In the seventh embodiment of the present disclosure, the execution process that uses the genetic algorithm is performed. FIG. 16 is a flowchart related to the program execution process according to at least one embodiment of the present disclosure.

The computer apparatus 5 progresses the video game (step S401). Next, the computer apparatus 5 sets the plurality of style sets to be applied in generation of the image as the initial setting (step S402). The content of the style set disclosed in the fourth embodiment and FIG. 8 can be employed as necessary for the style set in the seventh embodiment of the present disclosure.

In step S402, the computer apparatus 5 sets the number (for example, 10) of generated images in advance as the initial setting. The computer apparatus 5 randomly generates style sets corresponding to the number of generated images. The plurality of style sets initially set by the computer apparatus 5 may be a random combination of the attributes illustrated in FIG. 8.

Next, the computer apparatus 5 decides whether or not to generate the image based on the style set (first attribute) of the viewpoint object and/or the personality (second attribute) of the viewpoint object (step S403). The “personality” of the viewpoint object may be set in advance in the viewpoint object as an attribute. A content related to the personality disclosed in the fourth embodiment can be employed as necessary for the personality.

In a case of generating the image (YES in step S403), the computer apparatus 5 decides the style set for generating the image (step S404). The style set may be selected from the plurality of style sets set in step S402 only for the first time, and for the second time or later, may be selected from the plurality of style sets on which the evaluation of the image described later is reflected. In a case of not generating the image (NO in step S403), step S403 is executed again at a predetermined timing.

Next, the computer apparatus 5 specifies the sight line based on the style set decided in step S404 (step S405). At this point, the coordinates as the viewpoint are decided based on the position (for example, the position coordinates of the eye portion) of the viewpoint object. That is, position coordinates to which the viewpoint object can move may be the viewpoint coordinates.

The viewpoint coordinates may be decided based on a trigger caused by an event or may be decided by searching for whether or not an image complying with the capturing target of the capturing method included in the style set can be captured from the position coordinates of the viewpoint object for each predetermined timing.

In step S405, the sight line may be specified based on not only the viewpoint coordinates and the style set but also the technical level described later. The technical level is an attribute that may be set in the viewpoint object, and may be an attribute that is not tied to the style set.

The method of deciding the composition of the photo may be changed in accordance with the technical level. For example, a case where the style is “portrait” will be described. In a case where the technical level is low, the ratio at which the figure object of the capturing target is included in the image is increased, and an awkward image may be generated. Meanwhile, in a case where the technical level is high, an appropriate image in which the ratio of the figure object of the capturing target and the surrounding space are balanced may be generated. In such a manner, the master data in which the ratio of the capturing target is defined may be set in advance in accordance with the technical level. Furthermore, the ratio determined by the master data may be changed based on the evaluation described later.

Next, the computer apparatus 5 generates the image independently of the instruction operation of the player of the video game based on the specified sight line direction and the style set (first attribute) of the viewpoint object (step S406). Generation of the image is performed by rendering from the scene layout setting constituting the three-dimensional virtual space.

Next, the computer apparatus 5 processes the image generated in step S406 based on the style set (first attribute) of the viewpoint object (step S407). For example, a case of using the “filter” or a case of using the “monochrome film” as the accessory is exemplified as processing based on the style set. The tone or the brightness can be adjusted, and the individuality of the viewpoint object can be represented.

In processing of the image, it is preferable that the image is processed based on the information constituting the three-dimensional virtual space. By using the configuration information about the three-dimensional virtual space, for example, the image can be processed by considering the information related to depth.

Next, the computer apparatus 5 determines whether or not all of the plurality of style sets prepared for the image generation have been used (step S408). In a case where not all of the style sets are used (NO in step S408), a return is made to step S403 again, and the process continues.

In a case where generation of the expected number of images is finished (YES in step S408), the computer apparatus 5 receives evaluations of the generated images (step S409), The evaluations may be evaluations from the player who plays the game, or may be evaluations from the NPC object different from the viewpoint object. It is preferable that evaluation is performed on all images generated in step S406.

Next, the computer apparatus 5 reflects the evaluations received by the image evaluation unit 509 in step S409 on the style sets applicable to the subsequent image generation (step S410). Contents related to reflection of the evaluation on the style set in the fourth embodiment and contents in FIGS. 9A and 9B can be employed as necessary for reflection of the evaluation on the style set in the seventh embodiment.

Next, the computer apparatus 5 determines whether or not the condition for changing the technical level is satisfied (step S411). For example, the condition for changing the technical level is exemplified such that the predetermined number of images are generated, the cumulative number of times good evaluations are received exceeds the predetermined value, good evaluations with respect to the images generated using the plurality of style sets for generating the image exceed the predetermined ratio (example: out of 10 generated images, 7 or 70% or more have the evaluation GOOD). Alternatively, a case where the cumulative number of times bad evaluations are received exceeds the predetermined value, or a case where bad evaluations exceed the predetermined ratio may be available.

In a case where the condition is satisfied in step S411 (YES in step S411), the computer apparatus 5 changes the technical level of the target viewpoint object (step S412). A return is made to the process of step S403, and generation of the image further continues using new style sets on which the evaluations in step S409 are reflected. In a case where the condition is not satisfied in step S411 (NO in step S411), the computer apparatus 5 returns to the process of step S403 and repeatedly executes the image generation. The pause or the finish of the game is exemplified as the condition for finishing the program execution process.

In the above example, while the genetic algorithm is used for deciding the style set, the embodiment of the present disclosure is not limited thereto. For example, a predetermined evaluation value may be calculated for all style sets, and a style set having the highest evaluation value may be employed. Alternatively, after calculating the evaluation value for all style sets, an approximate value indicating how a style set having a high evaluation value and a style set usable by the viewpoint object are approximate may be calculated, and a style set having a high approximate value (similar) may be employed.

In the above example, while the sight line is specified based on the style set, the embodiment of the present disclosure is not limited thereto. For example, the sight line may be aligned to any direction, and then, the style set may be applied.

In the above example, while the technical level is described as an attribute that may be set for each viewpoint object, the embodiment of the present disclosure is not limited thereto. For example, the technical level may be set for each style set or each attribute such as the capturing method.

In the above example, while the computer apparatus is used, the embodiment of the present disclosure is not limited thereto. For example, instead of a storage of the computer apparatus, a distributed ledger used in the blockchain technology may be used.

In the above example, while the game program is exemplified, the embodiment of the present disclosure is not limited thereto. For example, the present embodiment may be applied to a program for depicting a painting in the real space using AI.

As one aspect of the seventh embodiment, a new image generation system of higher interest can be provided.

As one aspect of the seventh embodiment, by including the image generation decision unit, an image generation system of higher interest that can reflect a difference in attribute of the viewpoint object on the image generation can be provided.

As one aspect of the seventh embodiment, by generating the image corresponding to the technical level set in the viewpoint object, different images can be provided for each viewpoint object.

As one aspect of the seventh embodiment, by setting the technical level in each viewpoint object, two axes of a style and the technical level can be used as elements involved in the image generation, and a more complex image generation system of higher interest can be provided.

As one aspect of the seventh embodiment, by including the image evaluation unit and the technical level changing unit, the evaluation with respect to the image can be reflected on the technical level and consequently, reflected on the image generation, and a dynamic image generation system of higher interest can be provided.

As one aspect of the seventh embodiment, by including the image processing unit, the number of variations of images that can be generated can be increased, and an image generation system of higher interest can be provided.

As one aspect of the seventh embodiment, by causing the image processing unit to process the image based on the information constituting the three-dimensional virtual space, the image can be processed using more information, and a more attractive image can be generated.

In the seventh embodiment, contents disclosed in the first embodiment can be employed as necessary for each of the “three-dimensional virtual space”, the “viewpoint coordinates”, the “viewpoint object”, the “object”, the “sight line direction”, the “first attribute”, and “independently of the instruction operation of the player”. Contents disclosed in the second embodiment can be employed as necessary for the “second attribute”. Contents disclosed in the third embodiment can be employed as necessary for the “technical level”. Contents disclosed in the fourth embodiment can be employed as necessary for each of the “information constituting the three-dimensional virtual space” and the “style set” Contents disclosed in the sixth embodiment can be employed as necessary for each of the “computer apparatus”.

### Eighth Embodiment

A summary of an eighth embodiment of the present disclosure will be described. Hereinafter, the image generation program for generating the image representing the progress status of the video game which uses the three-dimensional virtual space in the computer apparatus operated by one or more players will be illustratively described as the eighth embodiment. In addition, the image generation program that uses the genetic algorithm will be illustratively exemplified as the image generation program in the eighth embodiment of the present disclosure.

Various objects may be arranged in the three-dimensional virtual space.

For example, the objects have the attributes of the light source object, the landform object, the character object, the building object, the natural object, and the like. The viewpoint object that is the object corresponding to the viewpoint coordinates for generating the image refers to an object as the viewpoint coordinates among any objects.

The configuration of the client terminal illustrated in the fourth embodiment can be employed as necessary for a configuration of the computer apparatus in the eighth embodiment of the present disclosure.

### System Summary

Next, a summary of the system assumed in the eighth embodiment of the present disclosure will be described. In the eighth embodiment, the image generation program for generating the image representing the progress status of the video game which uses the three-dimensional virtual space in the computer apparatus operated by one or more players will be illustratively described. As one example of the video game, the RPG in which the object (hereinafter, referred to as the player object) that acts in accordance with the operation instruction of the player can move in the three-dimensional virtual space is exemplified.

The player object can form a party with the NPC object controlled by the computer apparatus. Hereinafter, in the eighth embodiment of the present disclosure, the game system in which the image of the inside of the three-dimensional virtual space viewed from the NPC object (hereinafter, referred to as the viewpoint object) which acts together with the player object is depicted as a painting by the viewpoint object will be described as one example.

### Functional Description

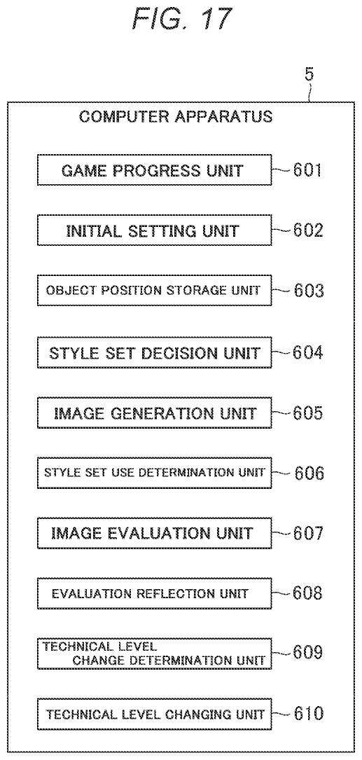

Functions of the computer apparatus 5 will be described. FIG. 17 is a block diagram illustrating a configuration of the computer apparatus according to at least one embodiment of the present disclosure.

The computer apparatus 5 may include a game progress unit 601, an initial setting unit 602, an object position storage unit 603, a style set decision unit 604, an image generation unit 605, a style set use determination unit 606, an image evaluation unit 607, an evaluation reflection unit 608, a technical level change determination unit 609, and a technical level changing unit 610.

The game progress unit 601 has a function of progressing the video game. The initial setting unit 602 has a function of setting the plurality of style sets to be applied in generation of the image. The object position storage unit 603 has a function of storing the position of the object, in the three-dimensional virtual space, that can be visually recognized by the virtual camera from any viewpoint coordinates at the predetermined timing in the video game.

The style set decision unit 604 has a function of deciding the style set to be used for generating the image. The image generation unit 605 has a function of generating a new image independently of the instruction operation of the player of the video game based on the position of the object stored in the object position storage unit 603. The image in the eighth embodiment of the present disclosure is not limited to an image corresponding to the photo described in the seventh embodiment and may be, for example, an image of a tool, an article, a person, a sculpture, or a painting.

The style set use determination unit 606 has a function of determining whether or not all style sets set by the initial setting unit 602 have been used. The image evaluation unit 607 has a function of receiving an evaluation of the image generated by the image generation unit 605.

The evaluation reflection unit 608 has a function of reflecting the evaluation received by the image evaluation unit 607 on the style set applicable in the subsequent image generation. The technical level change determination unit 609 has a function of determining whether or not the condition for changing the technical level is satisfied. The technical level changing unit 610 has a function of changing the technical level in a case where the technical level change determination unit 609 determines that the condition for changing the technical level is satisfied.

### Execution Process Flow

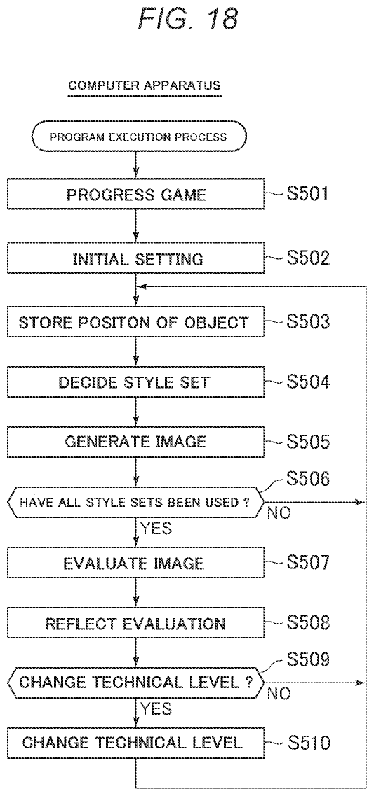

In the eighth embodiment of the present disclosure, the program execution process that uses the genetic algorithm is performed as one example. FIG. 18 is a flowchart related to the program execution process according to at least one embodiment of the present disclosure.

The computer apparatus 5 progresses the video game (step S501). Next, the computer apparatus 5 sets the plurality of style sets to be applied in generation of the image as the initial setting (step S502). The content of the style set disclosed in the fifth embodiment and FIG. 12 can be employed as necessary for the style set in the eighth embodiment of the present disclosure.

In step S502, the computer apparatus 5 sets the number (for example, 10) of generated images in advance as the initial setting. The computer apparatus 5 generates style sets corresponding to the number of generated images. The plurality of style sets initially set by the computer apparatus 5 may be a random combination of the attribute values illustrated in FIG. 12.

Next, the computer apparatus 5 stores the position of the object, in the three-dimensional virtual space, that can be visually recognized by the virtual camera from any viewpoint coordinates at the predetermined timing in the video game (step S503). At this point, the viewpoint coordinates are decided based on the position (for example, the position coordinates of the eye portion) of the viewpoint object. That is, position coordinates to which the viewpoint object can move may be the viewpoint coordinates.

Next, the computer apparatus 5 decides the style set for generating the image (step S504). The style set may be selected from the plurality of style sets set in step S502 only for the first time, and for the second time or later, may be selected from the plurality of style sets on which the evaluation of the image described later is reflected.

Next, the computer apparatus 5 generates the image independently of the instruction operation of the player of the video game based on the positional information about the object stored in step S503 and the style set (the first attribute of the viewpoint object) decided in step S504 (step S505). Generation of the image is performed by rendering from the scene layout setting constituting the three-dimensional virtual space.

In generation of the image, the style set in step S504 may be decided in accordance with the technical level described later. For example, a case where the depiction target is the “figure object (singular)” will be described, In a case where the technical level is low, the ratio at which the figure object as one motif is included in the image (painting) is increased, and an awkward image (painting) may be generated. Meanwhile, in a case where the technical level is high, an appropriate image (painting) in which the ratio of the figure object as one motif and the surrounding space are balanced may be generated. In such a manner, the master data in which the ratio of the motif is defined may be set in advance in accordance with the technical level. Furthermore, the ratio determined by the master data may be changed based on the evaluation described later.

In generation of the image, it is preferable that the image is generated based on the information constituting the three-dimensional virtual space. By generating the image by considering the configuration information about the three-dimensional virtual space, for example, the information related to depth, a more complex image than in a case of converting two-dimensional image data can be generated.

For example, the image may be generated based on the motif of the object arranged in the three-dimensional virtual space. At this point, the effect or the color of the light source object may not be considered in the motif of the object. Alternatively, for example, generation of the image may be such that a new image is generated by processing the image obtained by imaging the inside of the three-dimensional virtual space in accordance with the predetermined rule. That is, the image representing the three-dimensional virtual space may be initially generated, and the generated image may be processed in accordance with the style set of the viewpoint object.

Next, the computer apparatus 5 determines whether or not all of the plurality of style sets prepared for the image generation have been used (step S506). In a case where not all of the style sets are used (NO in step S506), a return is made to step S503 again, and the process continues.

In a case where generation of the expected number of images is finished (YES in step S506), the computer apparatus 5 receives evaluations of the generated images (step S507), The evaluations may be evaluations from the player who plays the game, or may be evaluations from the NRC object different from the viewpoint object. It is preferable that evaluation is performed on all generated images.

Next, the computer apparatus 5 reflects the evaluations received by the image evaluation unit 607 in step S507 on the style sets applicable to the subsequent image generation (step S508). Contents related to reflection of the evaluation on the style set in the fourth embodiment can be employed as necessary for reflection of the evaluation on the style set in the eighth embodiment.

Next, the computer apparatus 5 determines whether or not the condition for changing the technical level is satisfied (step S509). For example, the condition for changing the technical level is exemplified such that the cumulative number of times good evaluations are received exceeds the predetermined value, good evaluations with respect to the images generated using the plurality of style sets for generating the image exceed the predetermined ratio (example: out of 10 generated images, 7 or more or 70% or more have the evaluation GOOD). Alternatively, a case where a cumulative number of times bad evaluations are received exceeds a predetermined value, or a case where bad evaluations exceed a predetermined ratio may be available.

In a case where the condition is satisfied in step S509 (YES in step S509), the computer apparatus 5 changes the technical level of the target viewpoint object (step S510). The image is repeatedly generated using new style sets. In a case where the condition is not satisfied in step S509 (NO in step S509), the computer apparatus 5 returns to the process of step S503 and repeatedly executes the image generation. The pause or the finish of the game is exemplified as the condition for finishing the execution process.

In the above example, while the genetic algorithm is used for deciding the style set, the embodiment of the present disclosure is not limited thereto. For example, a predetermined evaluation value may be calculated for all style sets, and a style set having the highest evaluation value may be employed. Alternatively, after calculating the evaluation value for all style sets, an approximate value indicating how a style set having a high evaluation value and a style set usable by the viewpoint object are approximate may be calculated, and a style set having a high approximate value (similar) may be employed.

In the above example, while an example of not processing the image is described, the embodiment of the present disclosure is not limited thereto. For example, the generated image may be processed such that a shape of a view frustum (drawing region) of rendering is distorted in accordance with the technical level.

In the above example, while the sight line is not particularly mentioned, the image may be generated for each of both of left and right eyes.

In the above example, while the technical level is described as an attribute that may be set for each viewpoint object, the embodiment of the present disclosure is not limited thereto. For example, the technical level may be set for each style set or each attribute such as the capturing method.

In the above example, while the computer apparatus is used, the embodiment of the present disclosure is not limited thereto. For example, instead of a storage of the computer apparatus, a distributed ledger used in the blockchain technology may be used.

In the above example, while the game program is exemplified, the embodiment of the present disclosure is not limited thereto. For example, the present embodiment may be applied to a program for depicting a painting in the real space using AI.

As one aspect of the eighth embodiment, a new image generation system of higher interest can be provided.

As one aspect of the eighth embodiment, by generating the image corresponding to the technical level set in the viewpoint object, different images can be provided for each viewpoint object.

As one aspect of the eighth embodiment, by setting the technical level in each viewpoint object, two axes of the style and the technical level can be used as elements involved in the image generation, and a more complex image generation system of higher interest can be provided.

As one aspect of the eighth embodiment, by including the image evaluation unit and the technical level changing unit, the evaluation with respect to the image can be reflected on the technical level and consequently, reflected on the image generation, and a dynamic image generation system of higher interest can be provided.

As one aspect of the eighth embodiment, by causing the image generation unit to generate the image based on the information constituting the three-dimensional virtual space, the image can be generated using more information, and a more attractive image can be generated.

In the eighth embodiment, contents disclosed in the first embodiment can be employed as necessary for each of the “three-dimensional virtual space”, the “viewpoint coordinates”, the “viewpoint object”, the “object”, the “sight line direction”, the “first attribute”, and “independently of the instruction operation of the player”. Contents disclosed in the second embodiment can be employed as necessary for the “second attribute”. Contents disclosed in the third embodiment can be employed as necessary for the “technical level”. Contents disclosed in the fourth embodiment can be employed as necessary for each of the “information constituting the three-dimensional virtual space” and the “style set”. Contents disclosed in the fifth embodiment can be employed as necessary for each of the “image representing the progress status”. Contents disclosed in the sixth embodiment can be employed as necessary for each of the “computer apparatus”.

### Appendix

The above embodiments have been described such that the following disclosure can be embodied by those who have ordinary knowledge in the field to which the disclosure belongs.

(1) An image generation program executed in a server apparatus of an image generation system that includes a client terminal and the server apparatus connectable to the client terminal by communication and generates an image representing a progress status of a video game which uses a three-dimensional virtual space, the image generation program causing the server apparatus to function as game progress means for progressing the video game, sight line specifying means for specifying, using any viewpoint coordinates as a viewpoint for generating the image representing the progress status of the video game, a sight line direction of a viewpoint object that is an object corresponding to the viewpoint coordinates, and image generation means for generating the image independently of an instruction operation of a player of the video game based on the specified sight line direction and a first attribute of the viewpoint object.

(2) The image generation program according to (1), further causing the server apparatus to function as image generation decision means for deciding whether or not to generate the image based on the first attribute and/or a second attribute of the viewpoint object.

(3) The image generation program according to (1) or (2), in which a technical level for generating the image is set in the viewpoint object, and the image generation means generates the image corresponding to the technical level of the viewpoint object based on the sight line direction specified by the sight line specifying means and the first attribute of the viewpoint object

(4) The image generation program according to (3), in which the technical level is set for each viewpoint object.

(5) The image generation program according to (3) or (4), further causing the server apparatus to function as image evaluation means for receiving an evaluation of the image generated by the image generation means, and technical level changing means for changing the technical level of the viewpoint object based on the received evaluation.

(6) The image generation program according to any one of (1) to (5), further causing the server apparatus to function as image processing means for processing the image generated by the image generation means based on the first attribute of the viewpoint object.

(7) The image generation program according to (6), in which the image processing means processes the image based on information constituting the three-dimensional virtual space.

(8) A server apparatus on which the image generation program according to any one of (1) to (7) is installed.

(9) An image generation system that includes a client terminal and the server apparatus connectable to the client terminal by communication and generates an image representing a progress status of a video game which uses a three-dimensional virtual space, the image generation system including game progress means for progressing the video game, sight line specifying means for specifying, using any viewpoint coordinates as a viewpoint for generating the image representing the progress status of the video game, a sight line direction of a viewpoint object that is an object corresponding to the viewpoint coordinates, and image generation means for generating the image independently of an instruction operation of a player of the video game based on the specified sight line direction and a first attribute of the viewpoint object.

(10) An image generation program executed in a client terminal of an image generation system that includes the client terminal and a server apparatus connectable to the client terminal by communication and generates an image representing a progress status of a video game which uses a three-dimensional virtual space, the image generation program causing the client terminal to function as game progress means for progressing the video game, sight line specifying means for specifying, using any viewpoint coordinates as a viewpoint for generating the image representing the progress status of the video game, a sight line direction of a viewpoint object that is an object corresponding to the viewpoint coordinates, and image generation means for generating the image independently of an instruction operation of a player of the video game based on the specified sight line direction and a first attribute of the viewpoint object.

(11) A client terminal on which the image generation program according to (10) is installed.

(12) An image generation method executed in a server apparatus of an image generation system that includes a client terminal and the server apparatus connectable to the client terminal by communication and generates an image representing a progress status of a video game which uses a three-dimensional virtual space, the image generation method including game progress means for progressing the video game, sight line specifying means for specifying, using any viewpoint coordinates as a viewpoint for generating the image representing the progress status of the video game, a sight line direction of a viewpoint object that is an object corresponding to the viewpoint coordinates, and image generation means for generating the image independently of an instruction operation of a player of the video game based on the specified sight line direction and a first attribute of the viewpoint object.

(13) An image generation method of generating an image representing a progress status of a video game which includes a client terminal and a server apparatus connectable to the client terminal by communication and uses a three-dimensional virtual space, the image generation method including game progress means for progressing the video game, sight line specifying means for specifying, using any viewpoint coordinates as a viewpoint for generating the image representing the progress status of the video game, a sight line direction of a viewpoint object that is an object corresponding to the viewpoint coordinates, and image generation means for generating the image independently of an instruction operation of a player of the video game based on the specified sight line direction and a first attribute of the viewpoint object.

(14) An image generation program executed in a computer apparatus that generates an image representing a progress status of a video game which uses a three-dimensional virtual space, the image generation program causing the computer apparatus to function as game progress means for progressing the video game, sight line specifying means for specifying, using any viewpoint coordinates as a viewpoint for generating the image representing the progress status of the video game, a sight line direction of a viewpoint object that is an object corresponding to the viewpoint coordinates, and image generation means for generating the image independently of an instruction operation of a player of the video game based on the specified sight line direction and a first attribute of the viewpoint object.

(15) A terminal apparatus on which the image generation program according to (14) is installed.

(16) An image generation method executed in a computer apparatus that generates an image representing a progress status of a video game which uses a three-dimensional virtual space, the image generation method including game progress means for progressing the video game, sight line specifying means for specifying, using any viewpoint coordinates as a viewpoint for generating the image representing the progress status of the video game, a sight line direction of a viewpoint object that is an object corresponding to the viewpoint coordinates, and image generation means for generating the image independently of an instruction operation of a player of the video game based on the specified sight line direction and a first attribute of the viewpoint object,

(17) An image generation program executed in a server apparatus of an image generation system that includes a client terminal and the server apparatus connectable to the client terminal by communication and generates an image representing a progress status of a video game which uses a three-dimensional virtual space, the image generation program causing the server apparatus to function as game progress means for progressing the video game, object position storage means for storing a position of an object, in the three-dimensional virtual space, that is visually recognizable by a virtual camera from any viewpoint coordinates, and image generation means for generating the image independently of an instruction operation of a player of the video game based on the stored position of the object and a first attribute of a viewpoint object that is an object corresponding to the viewpoint coordinates.

(18) A server apparatus on which the image generation program according to (17) is installed.

(19) An image generation program executed in an image generation system that includes a client terminal and a server apparatus connectable to the client terminal by communication and generates an image representing a progress status of a video game which uses a three-dimensional virtual space, in which the image generation system includes game progress means for progressing the video game, object position storage means for storing a position of an object, in the three-dimensional virtual space, that is visually recognizable by a virtual camera from any viewpoint coordinates, and image generation means for generating the image independently of an instruction operation of a player of the video game based on the stored position of the object and a first attribute of a viewpoint object that is an object corresponding to the viewpoint coordinates.

(20) An image generation method executed in a server apparatus of an image generation system that includes a client terminal and the server apparatus connectable to the client terminal by communication and generates an image representing a progress status of a video game which uses a three-dimensional virtual space, the image generation method including game progress means for progressing the video game, and image generation means for generating the image independently of an instruction operation of a player of the video game based on a stored position of an object and a first attribute of a viewpoint object that is an object corresponding to any viewpoint coordinates.

(21) An image generation method executed in an image generation system that includes a client terminal and a server apparatus connectable to the client terminal by communication and generates an image representing a progress status of a video game which uses a three-dimensional virtual space, the image generation method including game progress means for progressing the video game, and image generation means for generating the image independently of an instruction operation of a player of the video game based on a stored position of an object and a first attribute of a viewpoint object that is an object corresponding to any viewpoint coordinates.

(22) An image generation program executed in a computer apparatus that generates an image representing a progress status of a video game which uses a three-dimensional virtual space, the image generation program causing the computer apparatus to function as game progress means for progressing the video game, object position storage means for storing a position of an object, in the three-dimensional virtual space, that is visually recognizable by a virtual camera from any viewpoint coordinates, and image generation means for generating the image independently of an instruction operation of a player of the video game based on the stored position of the object and a first attribute of a viewpoint object that is an object corresponding to the viewpoint coordinates.

(23) A terminal apparatus on which the image generation program according to (22) is installed.

(24) An image generation method executed in a computer apparatus that generates an image representing a progress status of a video game which uses a three-dimensional virtual space, the image generation method including dame progress means for progressing the video game, and image generation means for generating the image independently of an instruction operation of a player of the video game based on a stored position of an object and a first attribute of a viewpoint object that is an object corresponding to any viewpoint coordinates.

1. A non-transitory computer-readable recording medium having recorded thereon an image generation program executed in a server apparatus of an image generation system, the image generation program causing a computer of the server apparatus to perform functions comprising:
connecting to a client terminal by communication;
progressing a video game that uses a three-dimensional virtual space;
specifying, using viewpoint coordinates as a viewpoint, a sight line direction of a viewpoint object corresponding to the viewpoint coordinates; and
generating an image representing a progress status of the video game based on the specified sight line direction and a first attribute of the viewpoint object.

2. The non-transitory computer-readable recording medium having recorded thereon the image generation program according to claim 1, the functions further comprising:
deciding whether or not to generate the image based on at least one of the first attribute or a second attribute of the viewpoint object.

3. The non-transitory computer-readable recording medium having recorded thereon the image generation program according to claim 1, wherein a technical level for generating the image is set in the viewpoint object, the functions further comprising:
generating the image corresponding to the technical level of the viewpoint object based on the sight line direction specified and the first attribute of the viewpoint object.

4. The non-transitory computer-readable recording medium having recorded thereon the image generation program according to claim 3, wherein the technical level is set for each viewpoint object.

5. The non-transitory computer-readable recording medium having recorded thereon the image generation program according to claim 3, the functions further comprising:
receiving an evaluation of the generated image; and
changing the technical level of the viewpoint object based on the received evaluation.

6. The non-transitory computer-readable recording medium having recorded thereon the image generation program according to claim 1, the functions further comprising:
processing the generated image based on the first attribute of the viewpoint object.

7. The non-transitory computer-readable recording medium having recorded thereon the image generation program according to claim 6, wherein processing the generated image based on information that configures the three-dimensional virtual space.

8. An image generation system comprising:
a client terminal;
a server apparatus configured to connect to the client terminal by communication and further configured to generate an image representing a progress status of a video game which uses a three-dimensional virtual space; and
a computer configured to:
progress the video game;
specify, using viewpoint coordinates as a viewpoint, a sight line direction of a viewpoint object corresponding to the viewpoint coordinates; and
generate the image based on the specified sight line direction and a first attribute of the viewpoint object.

9. A non-transitory computer-readable recording medium having recorded thereon an image generation program executed in a client terminal of an image generation system, the image generation program causing a computer of the client terminal to perform functions comprising:
connecting to a server apparatus by communication;
progressing a video game that uses a three-dimensional virtual space;
specifying, using viewpoint coordinates as a viewpoint, a sight line direction of a viewpoint object that is an object corresponding to the viewpoint coordinates; and
generating an image representing a progress status of the video game based on the specified sight line direction and a first attribute of the viewpoint object.
